(19) United States
(12) Patent Application Publication
(10) Pub. No.: US 2026/0223253 A1
(43) Pub. Date: Jul. 30, 2026

(54) THERMAL INFRARED RADIATOR APPARATUS

(71) Applicant: Beam Tech Inc., San Jose, CA (US)

(72) Inventors: Matthew Leanse, San Francisco, CA (US); Rohan Sanjay Pandya, Oakland, CA (US)

(21) Appl. No.: 19/573,918

(22) Filed: Mar. 20, 2026

Related U.S. Application Data
(63) Continuation-in-part of application No. 18/312,211, filed on May 4, 2023.
(60) Provisional application No. 63/364,215, filed on May 5, 2022.
(60) Provisional application No. 63/775,209, filed on Mar. 20, 2025.

(51) Int. Cl. H05B 3/00; F24D 13/02; F24D 19/02; F24D 19/10; G02B 5/10; G06V 20/00; G06V 20/68; G06V 40/16; H05B 1/02; H05B 3/06

(52) U.S. Cl. CPC H05B 3/008; F24D 13/02; F24D 19/0216; F24D 19/0243; F24D 19/1096; G02B 5/10; G06V 20/36; G06V 20/68; G06V 40/161; H05B 1/0277; H05B 3/0014; H05B 3/0023; H05B 3/06; F24D 2200/08; H05B 2203/016; H05B 2203/032

(57) ABSTRACT

One variation of a system includes a radiator unit configured to: translate along a track; transiently couple to a retention feature located on the track; and direct thermal radiation toward a space located below the radiator unit. The radiator unit includes: an emitter configured to emit thermal radiation; a primary reflector configured to collimate thermal radiation and direct thermal radiation toward a space located below the radiator unit; and a secondary reflector configured to reflect thermal radiation, emitted by the emitter, toward the primary reflector. This variation of the system also included a latch operable in: a latched position to couple the radiator unit to the retention feature and supply power to the radiator unit; and an unlatched position to decouple the radiator unit from the retention feature, terminate supply of power to the radiator unit, and permit translation of the radiator unit along the track.

### CROSS-REFERENCE TO RELATED APPLICATIONS

This Application is a continuation-in-part of U.S. patent application Ser. No. 18/312,211, filed on 4 May 2023, which claims the benefit of U.S. Provisional Application No. 63/364,215, filed on 5 May 2022, each of which is incorporated in its entirety by this reference.

This Application claims the benefit of U.S. Provisional Application No. 63/775,209, filed on 20 Mar. 2025, which is incorporated in its entirety by this reference.

This Application s related to International Application No. WO/2023/215466, filed on 4 May 2023, which is hereby incorporated in its entirety by this reference.

### TECHNICAL FIELD

This invention relates generally to the field of thermal radiators and, more specifically, to a new and useful thermal infrared radiator apparatus in the field of thermal radiators.

### BRIEF DESCRIPTION OF THE FIGURES

FIGS. 1A, 1B, and 1C are schematic representations of a system;

FIG. 2 is a schematic representation of one variation of the system;

FIGS. 3A, 3B, and 3C are schematic representations of one variation of the system; and

FIGS. 4A and 4B are schematic representations of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

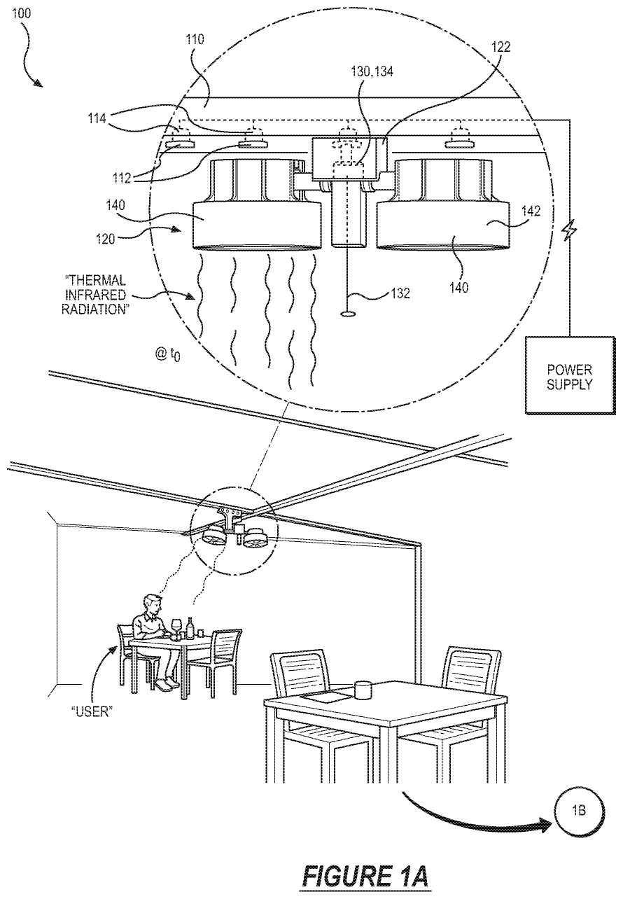

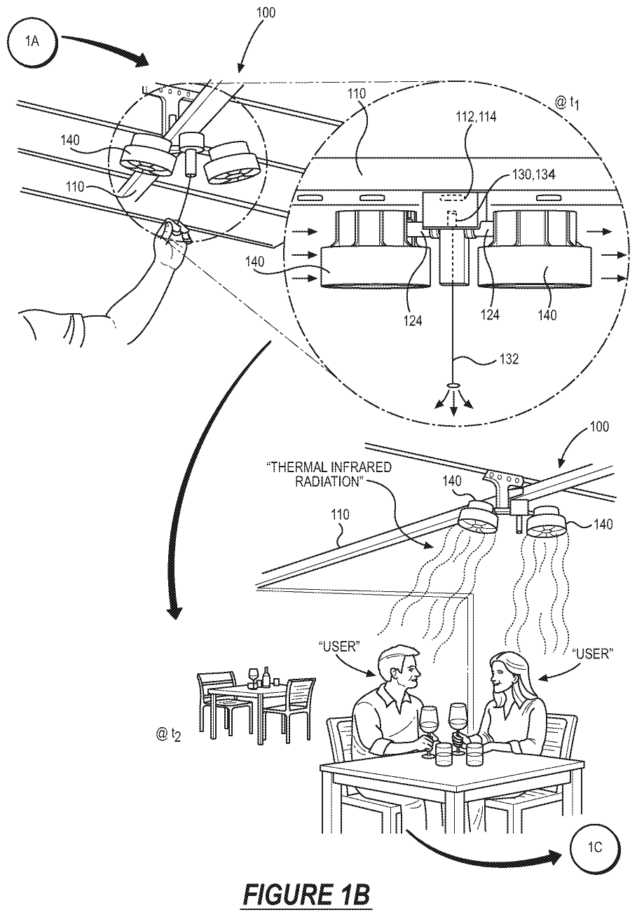

As shown in FIGS. 1A-1C, 2, 3A-3C, 4A, and 4B, a radiative heating system 100 includes: a track 110; a radiator unit 140; and a latch 130. The track 110 includes a set of retention features 112, each retention feature 112 in the set of retention features 112 arranged at a pitch distance from adjacent retention features 112.

The radiator unit 140 is configured to: translate along the track 110; and transiently couple to the set of retention features 112. The radiator unit 140 includes: an emitter 150; a primary reflector 160; and a secondary reflector 170. The emitter 150 is configured to emit thermal radiation. The primary reflector 160 is configured to: collimate thermal radiation; and direct thermal radiation toward a space located below the radiator unit 140. The secondary reflector 170 is: arranged proximal a distal end of the emitter 150; and configured to reflect thermal radiation, emitted by the emitter 150, toward the interior surface 162 of the primary reflector 160.

The latch 130 is operable in: a latched position to couple the radiator unit 140 to a retention feature 112 in the set of retention features 112; and an unlatched position to decouple the radiator unit 140 from the retention feature 112 and permit translation of the radiator unit 140 along the track 110.

### 1.1 Variation: Independently-Operable Radiative Heater

As shown in FIGS. 1A-1C, 2, and 3A-3C, one variation of a radiative heating system 100 includes a radiator unit 140: suspended from a track 110 located over a space; and configured to translate along the track 110 between a set of discrete positions to selectively heat the space.

The radiator unit 140 includes: a primary reflector 160; an emitter 150; and a secondary reflector 170. The primary reflector 160: defines an opening; and includes an interior surface 162.

The interior surface 162: is characterized by a geometric focus; and defines a focal region intersecting the geometric focus. The interior surface 162 is configured to: collimate thermal radiation; and direct thermal radiation toward the space. The emitter 150 is: arranged within the focal region; and configured to emit thermal radiation.

The secondary reflector 170 is: arranged within the focal region; and configured to reflect thermal radiation, emitted toward the opening by the emitter 150 without impinging on the interior surface 162, toward the primary reflector 160 for collimation by the interior surface 162.

### 1.2 Variation: Translatable Radiative Heater

As shown in FIGS. 1A-1C, 2, and 3A-3C, one variation of a radiative heating system 100 includes: a track 110; and a radiator unit 140. The track 110: includes a set of discrete positions, each discrete position arranged at a pitch distance from adjacent discrete positions; and is configured to supply power to a radiator unit 140 while the radiator unit 140 occupies the set of discrete positions.

The radiator unit 140 includes: an emitter 150; a primary reflector 160; and a secondary reflector 170. The emitter 150 is configured to emit thermal radiation. The primary reflector 160 is configured to direct thermal radiation toward a space located below the radiator unit 140. The secondary reflector 170 is: arranged proximal a distal end of the emitter 150; and configured to reflect thermal radiation, emitted by the emitter 150, toward the primary reflector 160.

The radiator unit 140 is configured to, in an intermediate mode, translate along the track 110 between the set of discrete positions while electrically isolated (i.e., disconnected) from the track 110. The radiator unit 140 is further configured to, in a heating mode: couple to the track 110 at a discrete position, in the set of discrete positions, located over a target region of the space; electrically couple to the track 110; and direct thermal radiation toward the target region of the space.

### 1.3 Variation: Focal-Region Emitter Configuration

As shown in FIGS. 1A-1C, 2, and 3A-3C, one variation of a radiative heating system 100 includes a thermal infrared radiator unit (hereinafter “radiator unit”) including: an emitter 150; a secondary reflector 170; and a primary reflector 160.

The emitter 150 (e.g., a ceramic infrared emitter) includes: a heating element 152 (e.g., a tungsten filament); and a ceramic layer 154 (e.g., a silicon nitride substrate) encompassing the heating element 152. The ceramic layer 154 emits thermal radiation (e.g., far-infrared radiation) responsive to heating by the heating element 152.

The secondary reflector 170: is coupled to a distal end of the emitter 150; obstructs an external line of sight to the emitter 150; and reflects thermal radiation, emitted by the emitter 150, to an interior surface 162 of the primary reflector 160.

The primary reflector 160: partially encloses the emitter 150 and the secondary reflector 170; is coupled to a proximal end of the emitter 150; defines a focal region occupied by the emitter 150 and the secondary reflector 170; and defines the interior surface 162 (e.g., parabolic, elliptical, hyperbolic) that reflects thermal radiation (i.e., emitted by the emitter 150 and redirected by the secondary reflector 170 within the focal region) as an approximately-collimated beam toward a target surface.

### 2. Applications

Generally, a radiator unit 140 (or “thermal engine”) is configured to output an approximately-collimated beam of thermal infrared energy (or “thermal radiation”) toward a target surface, such as a seating area in a restaurant or a torso of a user. In particular, the radiator unit 140 includes: an emitter 150 (e.g., a ceramic infrared emitter) that emits thermal radiation (e.g., far-infrared radiation); a primary reflector 160 coupled to a proximal end of the emitter 150; and a secondary reflector 170 coupled to a distal end of the emitter 150. The secondary reflector 170 is configured to redirect thermal radiation, emitted by the emitter 150, toward an interior surface 162 of the primary reflector 160. The interior surface 162 (e.g., parabolic, elliptical, hyperbolic) of the primary reflector 160 then: collects thermal radiation emitted by the emitter 150 (and thermal radiation redirected by the secondary reflector 170); and shapes this radiation into an approximately-collimated beam directed toward the target surface.

### 2.1 Emitter

In one application, the emitter 150 includes: a heating element 152 (e.g., a tungsten core); and a ceramic layer 154 (e.g., a silicon nitride substrate) encompassing the heating element 152. Accordingly, the ceramic layer 154 emits thermal radiation omnidirectionally responsive to heating by the heating element 152 following application of electrical current to the heating element 152 from a power source (e.g., alternating current power supply, direct current power supply). For example, the emitter 150 can include a cylindrical ceramic layer 154 that radially emits thermal radiation from a focal region of the primary reflector 160 and emits minimal radiation within the visible spectrum.

In particular, during operation of the radiator unit 140, the emitter 150 radiates thermal infrared energy proportional to the fourth power of an absolute temperature of the ceramic layer 154, as defined by the Stefan-Boltzmann Law. Accordingly, a controller 104 coupled to the radiator unit 140 can regulate electrical energy supplied to the heating element 152 (e.g., by adjusting voltage, modulating current, or varying pulse-width modulation (PWM) duty cycle) to maintain the temperature of the ceramic layer 154 within a target temperature range (e.g., between 1200° and 1300° Celsius), and thus sustain thermal radiation output from the radiator unit 140.

Thus, the emitter 150: emits thermal radiation at wavelengths within a far-infrared range (e.g., about 15 μm to about 1000 μm) based on the temperature of the ceramic layer 154; and suppresses radiation emission within wavelengths corresponding to a visible spectrum (e.g., about 400 nm to about 700 nm) based on emissivity characteristics of the ceramic layer 154.

### 2.2 Reflectors

The secondary reflector 170 (e.g., a diffuse reflector): is arranged at a distal end of the emitter 150; occupies the focal region of the primary reflector 160; reflects incident infrared energy emitted by the heating element 152 toward the primary reflector 160; and/or scatters incident visible light emitted by the heating element 152. For example, the secondary reflector 170 can be formed of a ceramic material (e.g., alumina) such that the secondary reflector 170 reflects incident infrared energy and scatters incident visible light. Furthermore, the primary reflector 160 (e.g., a specular reflector): partially encloses the emitter 150 and the secondary reflector 170; and defines an interior surface 162 characterized by a reflective profile (e.g., parabolic, elliptical) that reflects incident thermal radiation (i.e., redirected by the secondary reflector 170) from the focal region of the primary reflector 160 as an approximately-collimated beam to the target surface.

### 2.3 Operation

During operation of the radiator unit 140, the emitter 150 radiates thermal radiation toward an exterior surface of the secondary reflector 170 and an interior surface 162 of the primary reflector 160. The exterior surface of the secondary reflector 170 then redirects this thermal radiation along an external line of sight of the emitter 150 within the primary reflector 160 and toward the interior surface 162 of the primary reflector 160 to maintain confinement of thermal radiation within the focal region of the primary reflector 160. The interior surface 162 of the primary reflector 160 then: collimates wavefronts of the thermal radiation confined within the primary reflector 160 into an infrared beam of substantially parallel rays; and outputs an approximately-collimated thermal radiation beam across an opening of the primary reflector 160 and toward the target surface.

### 2.4 Targeted Heating+Personal Heat Source

Therefore, rather than dispersing thermal energy indiscriminately to heat a broad ambient space, the radiator unit 140 can output an approximately-collimated beam of thermal energy that can be selectively directed (e.g., along a thermal axis coaxial with the primary and secondary reflectors) toward a target surface (e.g., a human torso, a seat, a table) to selectively warm the target surface.

In one example, the radiator unit 140 is installed on a gantry (e.g., a one-axis, two-axis, or three-axis gantry) arranged over an outdoor patio table. In this example, the radiator unit 140 (or the gantry) can include an optical sensor 180 (e.g., a color camera) and a controller 104 configured to: detect and track a user in a video feed output by the optical sensor 180; and trigger the gantry to manipulate the radiator unit 140 to maintain the thermal axis of the radiator unit 140 proximal or intersecting the user while the radiator unit 140 outputs approximately-collimated thermal infrared energy along this thermal axis, thereby selectively (or solely, predominantly) heating the user (i.e., rather than the patio more generally). Similarly, the controller 104 can: detect absence of the user (e.g., user leaving a seating area) based on images captured by the optical sensor 180; calculate a position of an object (e.g., food, beverage container) placed on the table based on image data output by the optical sensor 180; and trigger the gantry to align the thermal axis of the radiator unit 140 with the calculated position, thereby emitting approximately-collimated thermal radiation toward the object.

In another example, the radiator unit 140 is installed in a bedroom (e.g., mounted to a wall, coupled to a floor stand, or coupled to a gantry) and configured to: direct thermal radiation toward the user to warm the user (e.g., rather than increasing an ambient temperature of the entire bedroom); and suppress visible radiation (e.g., wavelengths between about 380 nm and about 750 nm) to maintain minimal visible illumination during nighttime operation.

In yet another example, the radiator unit 140 is installed at an outdoor event space (e.g., mounted on poles, integrated into overhead gantry systems, or positioned on mobile stands) and configured to: detect positions of multiple users within the outdoor event space via optical sensors 180 (e.g., color cameras); drive orientation of each instance of the radiator unit 140 to align respective thermal axes with detected user positions; and emit directed approximately-collimated thermal radiation toward the detected users, rather than dispersing thermal energy indiscriminately within the outdoor event space.

### 2.5 Translatable Radiative Heating Systems

In one application, a radiative heating system 100 includes: a track 110 configured to install over a space occupied by humans, such as a restaurant patio, an outdoor dining area, a hospitality venue, a residential patio, or another semi-enclosed or open-air environment; and a set of (i.e., one or more) heater assemblies 120 mounted to the track 110 and configured to translate along the track 110 to locate over different regions of the space such as individual tables, seating areas, standing zones, or workstations. In particular, the track 110 (e.g., a freestanding or semi-freestanding support structure) can be configured to anchor to, mount on, or be secured to a ground surface, a deck surface, a wall surface, or a structural support, and suspend the set of heater assemblies 120 above the space. Additionally, each heater assembly 120 can include a set of (i.e., one or more) radiator units configured to generate and direct thermal radiation toward a particular region of the space, such as a user's torso, a user's face, a user's hands, or another target surface within the user-occupied zone. By concentrating thermal radiation toward the selected region rather than distributing heat omnidirectionally, the radiator unit 140 increases radiant flux incident on the selected surface while reducing unintended heating of adjacent areas.

In particular, at each discrete position, the track 110 can include: a retention feature 112 configured to transiently couple the heater assembly 120 to the track 110 at the discrete position; and a set of electrical connectors 134 configured to supply power to the heater assembly 120 (e.g., via an electrical connector 134 of the heater assembly 120) while the heater assembly 120 occupies the discrete position. Additionally, the heater assembly 120 can include: a latch 130 configured to selectively couple the radiator unit 140 to the track 110 at a particular discrete position along the track 110; an electrical connector 134 configured to couple to an electrical interface 114, located at a discrete position on the track 110, while the radiator unit 140 occupies the discrete position; and a cable 132 (e.g., a manual pull cable) configured to selectively decouple the radiator unit 140 from the retention feature 112 and toggle the supply of power to the radiator unit 140.

More specifically, a user may displace the cable 132 (e.g., by a short distance) to transition the radiator unit 140 between operational modes while maintaining the latch 130 in the latched position (i.e., maintaining electrical coupling to the power supply). Alternatively, the user may displace the cable 132 (e.g., by a greater distance) to: terminate supply of power to the radiator unit 140; and transition the latch 130 into an unlatched position to release the radiator unit 140 from the retention feature 112. The user may then manually translate (e.g., slide) the radiator unit 140 along the track 110 to a different discrete position and release the cable 132 to permit the latch 130 to re-engage at the different discrete position and reestablish electrical coupling.

Accordingly, the heater assembly 120 can be operable in an intermediate mode, wherein the heater assembly 120 can be translated (e.g., manually slid) along the track 110 between the set of discrete positions while electrically isolated from the track 110. Additionally, the heater assembly 120 can be operable in a heating mode, wherein the heater assembly 120 is: coupled to the track 110 at a discrete position located over a target region of the space (e.g., via a retention feature 112 of the track 110); electrically coupled to an electrical interface 114 located on the track 110 (e.g., via the electrical connector 134); and directing thermal radiation toward the target region of the space. Accordingly, rather than requiring a heater assembly 120 at every discrete position along the track 110, a single heater assembly 120 can be repositioned between discrete positions to service multiple regions of the space over time.

Therefore, the radiative heating system 100 is configured for retrofit installation onto extant infrastructure (e.g., beams, awnings, pergolas, overhangs) without requiring significant modification (or can form a standalone support structure) such that the radiative heating system 100 occupies minimal ground footprint and preserves usable (e.g., revenue-generating) floor space within the location. In particular, by suspending the radiator unit(s) 140 overhead, the track 110 reduces obstruction within the user-occupied zone and mitigates interference with seating layouts, pedestrian circulation paths, and extant table arrangements.

In one example, the radiative heating system 100 includes: a track 110 installed at a restaurant patio over a row of tables; and a set of heater assemblies 120 each including a pair of radiator units 140 and configured to translate along the track 110, above the row of tables, to locate above a particular table. In this example, each heater assembly 120 can independently translate along the track 110 and independently operate to direct thermal radiation toward distinct regions below the track 110. For example, a first radiator unit 140 can direct thermal radiation toward a first user seated at the table while a second radiator unit 140 directs thermal radiation toward a second user seated at the same table, such that each user receives localized heating at a selected body region (e.g., torso versus face) without requiring uniform heating of the entire table area. Thus, each radiator unit 140 can independently heat occupants seated at the particular table by articulating or reorienting toward the target surface and directing concentrated thermal radiation toward individual users or user-occupied surfaces.

### 3. Track

The track 110 can be configured to install over a space occupied by humans (e.g., an outdoor dining area) such that the radiator unit(s) 140 can translate along the track 110, above the space, and direct thermal radiation toward selectable regions within the space, as shown in FIG. 1A. In particular, the track 110 suspends the radiator unit(s) 140 above a user-occupied zone while maintaining clearance for occupants to move beneath the track 110.

In one example, the track 110 can include a horizontal crossmember: installed over a space, such as above a row of tables at an outdoor dining area or above an outdoor bar; and defining a longitudinal channel configured to mount the set of heater assemblies 120 to the horizontal crossmember. In particular, the longitudinal channel can be configured to interface with a mounting feature of a heater assembly 120, such as a sliding carriage, a roller assembly, or a keyed mounting bracket, thereby permitting translation of the heater assembly 120 along the horizontal crossmember.

In another example, the track 110 includes: a horizontal crossmember; and a set of (i.e., one or more) vertical members (e.g., upright members) configured to support the horizontal crossmember over the space. In particular, the vertical members can be configured to anchor to, mount on, or be secured to a ground surface, a deck surface, a wall surface, or a structural support, to suspend the horizontal crossmember above the space. In this example, the track 110 forms a freestanding or semi-freestanding support structure. For example, a freestanding or semi-freestanding track can be configured to install at a location (e.g., a restaurant) devoid of overhead structural infrastructure.

The track 110 is configured to interface with one or more heater assemblies 120 such that each heater assembly 120 can translate along the track 110 and transiently couple to the track 110 at discrete positions defined along the track 110. In particular, the track 110 can include a set of discrete positions for the heater assembly 120 to locate at along the track 110, each discrete position spaced apart from adjacent discrete positions by a pitch distance (e.g., one foot, two feet, three feet). More specifically, at each discrete position, the track 110 can include a retention feature 112 configured to transiently couple the heater assembly 120 to the track 110. For example, the track 110 can include a set of retention features 112, such as: detent features configured to interface with a spring-biased latch of the heater assembly 120; apertures, slots, or keyed recesses configured to receive a pin, tab, or projection of the heater assembly 120; or magnetic elements configured to couple to a ferromagnetic element of the heater assembly 120. However, the track 110 can include any other retention feature 112 configured to retain a heater assembly 120 at a discrete position, by resisting lateral translation of the heater assembly 120 when coupled at the discrete position, while permitting translation of the heater assembly 120 along the track 110 when the heater assembly 120 is disengaged or released from the discrete position.

In particular, the track 110 includes the set of discrete positions, spaced apart by a particular pitch distance, such that a heater assembly 120 can be repositioned over different regions of the space as occupancy and/or heating demand changes over time. As described below, an operator may manually release the heater assembly 120 from the discrete position (e.g., via a pull cable) and maneuver (e.g., pull) the heater assembly 120 along the track 110 to a different discrete position. For example, an operator may relocate a heater assembly 120 from a first position above an unoccupied table to a second position above an occupied table within the outdoor dining area. Accordingly, rather than requiring a heater assembly 120 at every discrete position along the track 110, a single heater assembly 120 can be repositioned between discrete positions to service multiple regions of the space over time.

The track 110 can further supply power to each heater assembly 120 mounted to the track 110. In particular, the track 110 can include a set of electrical interfaces 114 coupled to a power supply. More specifically, at each discrete position, the track 110 can include an electrical interface 114 configured to supply power to the heater assembly 120 (e.g., via an electrical connector 134 of the heater assembly 120) while the heater assembly 120 occupies the discrete position. For example, the track 110 can include a set of electrical interfaces 114, such as: pin type connectors configured to establish electrical continuity upon mechanical engagement with a receptacle of the radiator unit 140; or spring-loaded contact pads configured to mate with a conductive terminal of the radiator unit 140. However, the track 110 can include any other electrical interface 114 configured to supply power to the heater assembly 120.

Accordingly, the track 110 includes discrete indexed positions at which a heater assembly 120 is both mechanically retained and electrically coupled to a power supply. By co-locating mechanical retention and electrical coupling at the discrete positions, an operator may easily reposition the heater assembly 120 along the track 110 without separately disconnecting or reconnecting wiring. Additionally, by distributing electrical interfaces 114 along the track 110, the heater assembly 120 can: omit onboard energy storage and receive power directly from the track 110 at each indexed position; simplify electrical architecture within the heater assembly 120; and reduce weight and sizing requirements (e.g., associated with integrated power components) for the heater assembly 120.

### 4. Heater Assembly

Generally, the heater assembly 120 includes: a radiator unit 140 configured to mount to the track 110 and generate thermal radiation; an actuator 124 configured to articulate the radiator unit 140 to direct heat, generated by the radiator unit 140, toward a particular surface (e.g., a user's torso, a user's face) proximal (e.g., below) the radiator unit 140; a suite of sensors (e.g., optical sensors, distance sensors) configured to detect conditions (e.g., distances to nearby surfaces, occupancy state) proximal the radiator unit 140; and a controller 104 configured to trigger the radiator unit 140 to generate heat and trigger the actuator 124 to orient the radiator unit 140 based on signals output by the suite of sensors.

In particular, the heater assembly 120 can be configured for both translational repositioning along the track 110 and angular articulation of the radiator unit 140 relative to the track 110. For example, the heater assembly 120 can include a mount 122 (e.g., a carriage or support structure): interposed between the radiator unit 140 and the track 110; and configured to translate along the track 110, such as to reposition the heater assembly 120 between discrete positions without altering angular orientation of the radiator unit 140 relative to the mount 122.

The actuator 124 can be configured to maneuver the radiator unit 140 over a range of positions to direct heat, generated by the radiator unit 140, toward a particular surface. For example, the actuator 124 can include one or more motors, servomotors, stepper motors, or geared drive mechanisms configured to rotate the radiator unit 140 about one or more rotational axes relative to the mount 122. In one example, the actuator 124 can: articulate the radiator unit 140 through a range of pitch orientations to vary vertical aim of the radiator unit 140; and articulate the radiator unit 140 through a range of roll or yaw orientations to vary lateral aim of the radiator unit 140.

The heater assembly 120 can further include a suite of sensors configured to output signals to the controller 104. For example, the heater assembly 120 can include an optical sensor 180 (e.g., a two-dimensional color camera): defining a field of view intersecting the space located below the radiator unit 140; and configured to capture images depicting surfaces (e.g., a user's torso, a table surface) located in the space below the radiator unit 140 (or proximal the radiator unit 140).

Additionally or alternatively, the heater assembly 120 can include a distance sensor 182 configured to output a signal representing a distance between the distance sensor 182 and a reference surface (e.g., a table surface).

### 4.1 Radiator Unit

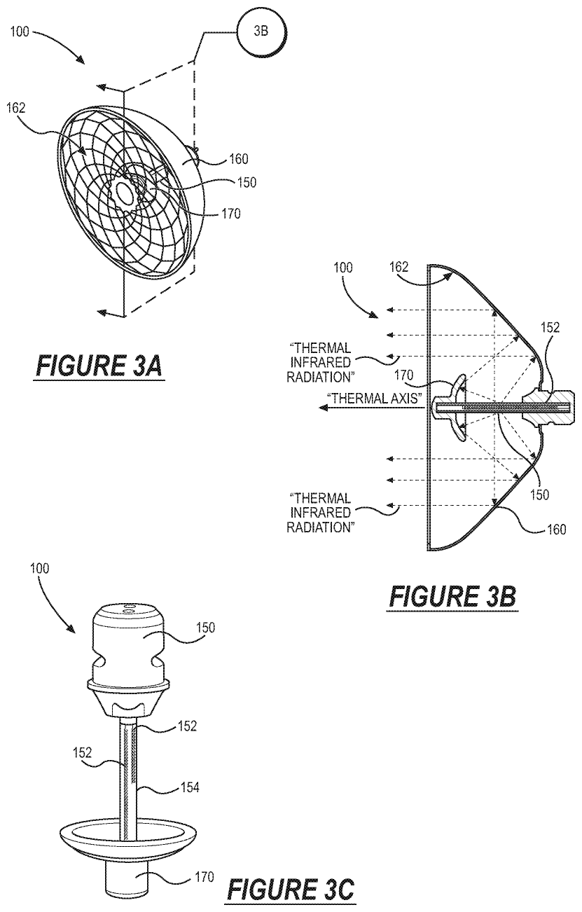

Generally, as shown in FIGS. 3A-3C, the radiator unit 140 is configured to: translate along the track 110 (e.g., via a mount 122) between a set of discrete positions to locate over a target region of the space; and generate and direct thermal radiation along a beam path toward a particular surface within the space. In particular, the radiator unit 140 includes: an emitter 150 configured to emit thermal radiation; a primary reflector 160 configured to collimate thermal radiation and direct thermal radiation toward the space located below the radiator unit 140; a secondary reflector 170 configured to reflect thermal radiation, emitted by the emitter 150, toward the primary reflector 160 to increase thermal radiation incident upon the primary reflector 160 (i.e., by recovering radiation that may otherwise bypass the primary reflector 160); and a housing 142 encapsulating the emitter 150, the primary reflector 160, and the secondary reflector 170.

### 4.1.1 Emitter

Generally, the emitter 150 is configured to emit thermal radiation that is redirected by the primary reflector 160 toward the space below the radiator unit 140 (i.e., to heat the space). In particular, the emitter 150 includes: a heating element 152 (e.g., a tungsten filament core, a tungsten heating element 152) configured to resistively generate heat responsive to application of electrical current through the heating element 152; and a ceramic layer 154 (e.g., a silicon nitride layer) encompassing or encapsulating (i.e., thermally coupled to) the heating element 152 and configured to radiate thermal radiation responsive to conductive heat transfer from the heating element 152. The emitter 150 includes: a proximal end located proximal the base of the primary reflector 160; and a distal end, opposite the proximal end, located proximal the secondary reflector 170.

The emitter 150 is arranged within an internal volume (e.g., defined by the concave interior surface 162) of the primary reflector 160 and configured to emit thermal radiation photons, these photons then propagating toward (and colliding with) the interior surface 162 of the primary reflector 160 or propagating toward the opening (or the secondary reflector 170) of the radiator unit 140. As described below, the interior surface 162 of the primary reflector 160 defines a focal region (i.e., a spatial region within the internal volume of the primary reflector 160), wherein thermal radiation photons, emitted by the emitter 150, are substantially reflected by the interior surface 162 at angles that result in collimation along the beam path. More specifically, when the emitter 150 is positioned within the focal region, a greater proportion of emitted thermal radiation intersects the interior surface 162 at reflection angles that redirect the radiation along substantially parallel trajectories aligned with the beam path (i.e., within the field of view of the radiator unit).

Accordingly, the emitter 150 can be arranged within the focal region: to increase thermal radiation incident upon the interior surface 162 of the primary reflector 160, thereby increasing radiant flux density along the beam path; and to increase a proportion of electrical input energy converted into directional thermal radiation incident upon a particular surface. By increasing radiant flux density and reducing beam divergence, the radiator unit 140 can permit localized heating of a particular surface (e.g., a user's torso or face) without requiring uniform heating of the surrounding space.

The emitter 150 defines an exterior surface configured to emit thermal radiation responsive to conductive heat transfer from the heating element 152. In particular, radiated power emitted by the exterior surface is proportional to surface area, emissivity, and surface temperature. More specifically, electrical current passing through the heating element 152 generates heat within the volume of the emitter 150, and conductive heat transfer distributes this heat to the exterior surface. Therefore, the magnitude of thermal radiation emitted from the exterior surface depends on both the temperature achieved at the exterior surface and the total surface area available for radiation (and emissivity of the surface). Accordingly, the emitter 150 can be arranged within the focal region and exhibit a relatively high surface-area-to-volume ratio to reduce thermal mass of the emitter 150 relative to radiating area, thereby reducing electrical energy required to reach an operating temperature and reducing temperature gradients across the exterior surface.

In particular, the emitter 150 can be configured to maintain a substantially uniform surface temperature across the exterior surface when operating at the operating temperature such that: the emitter 150 can emit thermal radiation with reduced spatial variation in intensity across the exterior surface; and radiation incident upon the interior surface 162 of the primary reflector 160 exhibits reduced angular and intensity variation prior to reflection. By increasing surface area available for radiation while limiting thermal mass and maintaining placement within the focal region, the emitter 150 increases radiant flux density directed along the beam path while reducing electrical input required to achieve a selected heating effect at a particular surface.

Accordingly, the emitter 150 generates resistive heating responsive to electrical current passing through the heating element 152 to induce Joule heating and elevate the temperature of the heating element 152 to an operating temperature (e.g., between approximately 1200° C. and approximately 1300° C.). The heating element 152 transfers heat via conduction to the surrounding ceramic layer 154 to elevate the temperature of the exterior surface of the ceramic layer 154. The exterior surface of the ceramic layer 154 emits thermal radiation omnidirectionally within the internal volume of the primary reflector 160 as a function of absolute surface temperature in accordance with the Stefan-Boltzmann relationship.

Furthermore, the heating element 152 is configured to operate within an operating temperature range (e.g., between approximately 1200° C. and approximately 1300° C.), wherein the ceramic layer 154 emits predominantly within the infrared spectrum while limiting visible-band emission and avoiding excessive thermal stress on surrounding components. Accordingly, the heating element 152 is formed of a material (e.g., tungsten) that exhibits: a relatively high electrical resistivity to generate heat under application of electrical current while maintaining structural integrity at operating temperatures of the emitter 150; and mechanical strength and dimensional stability at elevated temperatures, such as to resist deformation, creep, or fracture during repeated thermal cycling. The ceramic layer 154 is formed of a material (e.g., silicon nitride) that: exhibits a relatively high infrared emissivity (and/or a relatively high ratio of infrared emissivity to visible-light emissivity); and exhibits thermal stability, resistance to oxidation, and resistance to chemical degradation at operating temperatures of the heating element 152. In particular, the ceramic layer 154 is configured to isolate the heating element 152 from the ambient environment, while permitting conductive heat transfer from the heating element 152 to the exterior surface of the ceramic layer 154 and emission of thermal radiation from the exterior surface, such that the heating element 152 can operate at elevated temperatures without direct exposure to oxygen that may accelerate oxidation and material degradation.

For example, the emitter 150 can include: a tungsten heating element 152 configured to resistively generate heat responsive to electrical current; and a silicon nitride layer encapsulating the tungsten heating element 152 and configured to chemically isolate the heating element 152 from oxygen by forming a barrier between the tungsten heating element 152 and ambient air, thereby reducing oxidation of tungsten at elevated temperature and extending operational lifetime of the emitter 150. Additionally, the silicon nitride layer can be further configured to conduct and laterally distribute heat generated by the tungsten heating element 152 across the silicon nitride layer to promote more uniform emission of thermal radiation.

Thus, the emitter 150 can be configured to emit relatively high densities of thermal radiation (e.g., exceeding 90% emissivity in the 3-15 micron range) while minimizing visible light radiation (e.g., reducing emissions below 1% in the 400-700 nanometer range). In particular, energy emitted in the visible spectrum contributes less effectively to heating of human skin relative to infrared radiation. Therefore, by emitting energy within the infrared band, the emitter 150: increases heating effectiveness per unit electrical input; and limits glare and visual distraction of the radiator unit 140. Furthermore, by operating within a temperature range corresponding to infrared-dominant emission, the radiator unit 140 reduces thermal stress on materials, thereby increasing life span of the radiator unit 140 and reducing risk of ignition of nearby objects (e.g., relative to operation at higher temperatures required for visible incandescence).

In one example, the emitter 150 includes: a heating element 152; and a double-conical ceramic layer 154 that tapers at both ends to encapsulate the heating element 152. In this example, the ceramic layer 154 can taper at both ends to increase the proportion of emitted thermal radiation directed radially outward within the internal volume of the primary reflector 160. In particular, the sloped surfaces emit thermal radiation over a wide angular distribution relative to a central longitudinal axis of the emitter 150. The double-conical geometry positions the emitting surfaces within the internal volume of the primary reflector 160 such that a substantial portion of emitted radiation is incident upon the interior surface 162 of the primary reflector 160 for subsequent redirection along the beam path. Accordingly, rather than emitting thermal radiation along a single direction, the emitter 150: emits thermal radiation over a broad angular range within the internal volume of the primary reflector 160; distributes radiation across the interior surface 162 of the primary reflector 160 for collimation; suppresses visible-light emissions to reduce energy emitted outside of the infrared spectrum; and increases the proportion of emitted radiation redirected by the primary reflector 160 toward a selected surface.

In another example, the emitter 150 can include a coating (e.g., a silicon nitride coating or silicon carbide coating) formed over the ceramic layer 154, the coating selected to maintain a target surface emissivity at operating temperature and to reduce reflective losses at the exterior surface of the emitter 150.

In one variation, the emitter 150 includes a coiled filament (e.g., a coiled tungsten filament) that: extends longitudinally within the ceramic layer 154 to define a heating path within the ceramic layer 154; generates heat distribution along the coiled filament; and maintains heat transfer between the coiled filament and the ceramic layer 154 by evenly dispersing thermal energy from the coiled filament to the surrounding ceramic layer 154. Additionally, the emitter 150 includes a base that: is electrically coupled to the ends of the coiled filament to form a conductive path for current flow; and connects the coiled filament to an external power source to maintain electrical input and control thermal output. Thus, rather than implementing direct-core heating, the radiator unit 140 can include a coiled filament that: distributes heat evenly across the filament length to maintain relatively uniform temperature of the ceramic layer 154 and sustained emission of thermal radiation from the exterior surface of the ceramic layer 154.

In another variation, the emitter 150 includes a temperature sensor (e.g., thermocouple, thermistor, infrared sensor): coupled to the heating element 152 (e.g., arranged within the base of the emitter 150); and configured to output signals representing temperatures of the heating element 152 (e.g., a filament). In this variation, the controller 104 can selectively increase or decrease electrical current supplied across the heating element 152 based on temperature values output from the temperature sensor to maintain a target temperature range across the emitter 150 and maintain a target thermal radiation emission, as described below.

### 4.1.2 Primary Reflector

Generally, the primary reflector 160 is configured to direct thermal radiation, generated by the emitter 150, toward a particular surface, such as a particular surface of a user's body. More specifically, the primary reflector 160: collimates wavefronts of the thermal radiation confined within the primary reflector 160 into substantially parallel rays; and outputs an approximately-collimated thermal radiation beam (or “infrared beam”), through an opening of the primary reflector 160, along a beam path of the radiator unit 140 and toward the target surface.

The primary reflector 160 includes: a base; a rim arranged opposite the base and defining an opening; and an interior surface 162 extending between the base and the rim. The interior surface 162 is configured to: collimate thermal radiation; and direct this collimated thermal radiation through the opening and toward a surface located in the space below the radiator unit 140. In particular, the interior surface 162 defines a reflective geometry (e.g., parabolic, elliptical, or hyperbolic) and is formed of a reflective material (e.g., polished aluminum, gold-coated substrate, or dielectric-coated composite) to reflect thermal radiation as a collimated beam toward the opening. More specifically, the interior surface 162 exhibits concave surface geometry (e.g., elliptical, parabolic) configured to collimate incident thermal radiation at the interior surface 162 by shaping wavefront propagation of the thermal radiation, thereby generating a collimated beam that exits through the opening toward a particular surface. In particular, the interior surface 162 reflects incident thermal radiation such that angles of incidence relative to local surface normals determine angles of reflection. Accordingly, the curvature of the concave interior surface 162 positions local surface normals along the interior surface 162 such that radiation emitted from the emitter 150 (i.e., located within a focal region) reflects into propagation paths that are substantially parallel to one another and aligned with the beam path.

Furthermore, the interior surface 162 defines: an internal volume; and a focal region intersecting a geometric focus located in the internal volume of the interior surface 162. The focal region corresponds to a spatial region within the internal volume from which emitted thermal radiation, when incident upon the interior surface 162, reflects into propagation paths exhibiting reduced angular spread relative to one another. The emitter 150 is arranged within the focal region such that thermal radiation emitted from the emitter 150 and incident upon the interior surface 162 reflects into propagation paths that are substantially parallel and aligned with the beam path of the radiator unit 140. By positioning the emitter 150 within the focal region, radiation incident upon the interior surface 162 reflects in accordance with local surface normals defined by the concave geometry, thereby reducing divergence of the projected beam.

Additionally, the secondary reflector 170 is arranged within the focal region such that thermal radiation, emitted toward the opening without first impinging on the interior surface 162, is redirected toward the interior surface 162 for collimating reflection. Thus, both directly incident and secondary-redirected radiation undergo reflection at the concave interior surface 162 before exiting through the opening. Therefore, by defining a concave reflective geometry with a focal region occupied by the emitter 150 and redirecting radiation toward the interior surface 162, the primary reflector 160 reduces angular dispersion of emitted thermal radiation, thereby projecting an approximately-collimated beam toward the target surface.

### 4.1.3 Secondary Reflector

Generally, the secondary reflector 170 is configured to reflect thermal radiation toward the interior surface 162 of the primary reflector 160 to increase thermal radiation incident upon the interior surface 162 of the primary reflector 160. In particular, the secondary reflector 170 is configured to reflect thermal radiation, emitted toward the opening by the emitter 150 without impinging on the interior surface 162, toward the primary reflector 160 for collimation by the interior surface 162.

The secondary reflector 170 (e.g., a diffuse reflector, a specular reflector) can be: coupled to a distal end of the emitter 150; and configured to obstruct an external line of sight toward the emitter 150. In particular, during operation of the radiator unit 140, the emitter 150 generates thermal radiation as a function of surface temperature and omnidirectionally radiates this thermal radiation. Accordingly, thermal radiation photons emitted by the emitter 150 may propagate toward the interior surface 162 of the primary reflector 160 or propagate toward the opening of the primary reflector 160. More specifically, some thermal radiation photons, propagating toward the opening, may impinge upon the secondary reflector 170. Accordingly, the secondary reflector 170 can be arranged proximal the opening and within the focal region to intercept and reflect these photons toward the primary reflector 160 to increase photons incident on the primary reflector 160.

In particular, the secondary reflector 170 can be configured to redirect the incident thermal radiation toward the interior surface 162 of the primary reflector 160, such as by scattering, diffusing, or reflecting radiation along controlled angles based on surface geometry and material properties of the secondary reflector 170, thereby reducing radiative energy losses along the external line of sight and maintaining confinement of thermal radiation within the focal region of the primary reflector 160.

In one example, the secondary reflector 170 includes a diffuse reflector (e.g., parabolic, elliptical) formed of a metallic material (e.g., a polished or unpolished alumina casting) and configured to trap photons of thermal radiation traveling along the external line of sight and redirect these photons toward the interior surface 162 of the primary reflector 160.

In one implementation, during operation of the radiator unit 140, the secondary reflector 170: intercepts omnidirectional thermal radiation traveling along an external line of sight of the emitter 150; and redirects this intercepted radiation toward the interior surface 162 of the primary reflector 160 to reinforce radiative energy confinement at the focal region of the primary reflector 160. The primary reflector 160 then: captures thermal radiation (i.e., redirected by the secondary reflector 170) across the interior surface 162 of the primary reflector 160; redistributes incident thermal radiation across a reflective geometry (e.g., parabolic, elliptical, hyperbolic) of the primary reflector 160; collimates wavefronts of this incident radiation into an infrared beam of substantially parallel rays; and directs this collimated radiation toward the surface.

### 4.2 Latch

The heater assembly 120 can further include a latch 130 configured to selectively couple the radiator unit 140 to the track 110 at a particular discrete position along the track 110. In particular, the latch 130 is operable in: a latched position to transiently retain the radiator unit 140 at a discrete position, in the set of discrete positions, located on the track 110; and an unlatched position to release the radiator unit 140 from the discrete position and permit translation of the radiator unit 140 along the track 110. More specifically, in the latched position, the latch 130 is configured to couple the radiator unit 140 to a retention feature 112, in the set of retention features 112, located on the track 110. Conversely, in the unlatched position, the latch 130 is configured to: decouple the radiator unit 140 from the retention feature 112; and permit translation of the radiator unit 140 along the track 110.

Additionally, the heater assembly 120 can further include an electrical connector 134 configured to couple to an electrical interface 114, located at a discrete position on the track 110, while the radiator unit 140 occupies the discrete position to supply power to the radiator unit 140.

In one example, the latch 130 can be configured to: selectively decouple the radiator unit 140 from a retention feature 112 located on the track 110; and toggle the supply of power to the radiator unit 140. In particular, in this example, when transitioned from the unlatched position to the latched position at a discrete position, the latch 130 is configured to: couple the heater assembly 120 to the retention feature 112 at the discrete position (e.g., via a corresponding mating feature on heater assembly 120); and couple the electrical connector 134 to the electrical interface 114 to supply power to the radiator unit 140. Conversely, when transitioned from the latched position to the unlatched position at the discrete position, the latch 130 is configured to: decouple the heater assembly 120 from the retention feature 112; and decouple the electrical connector 134 from the electrical interface 114 to terminate supply of power to the radiator unit 140.

For example, the latch 130 can include a pin configured to engage a slot (e.g., a retention feature 112) located on the track 110. In this example, the pin can include an electrical connector 134 (e.g., a conductive contact) arranged on a distal end of the pin and configured to drive toward and engage a conductive terminal (i.e., an electrical interface 114) when the latch 130 is transitioned to the latched position.

Additionally, the heater assembly 120 can further include a cable 132 (e.g., a manual pull cable) coupled to: a switch configured to transition the radiator unit 140 between operational modes; and the latch 130. In particular, the cable 132 can be configured to: toggle the switch to transition the radiator unit 140 between operational modes responsive to displacement of the cable 132 by a first distance; and manipulate the latch 130 to decouple the radiator unit 140 from the retention feature 112 and terminate supply of power to the radiator unit 140 responsive to displacement of the cable 132 by a second distance greater than the first distance. For example, the switch can transition the radiator unit 140 between modes such as on or off, a low-power mode and a high-power mode, and/or a heating mode and a cooling mode.

For example, as shown in FIG. 1B, a user may displace the cable 132 by the first distance to toggle the switch and transition the radiator unit 140 between operational modes while maintaining the latch 130 in the latched position. Alternatively, the user may displace the cable 132 by the second distance to transition the latch 130 into the unlatched position, thereby releasing the radiator unit 140 from the retention feature 112 and terminating supply of power to the radiator unit 140. The user may then manually translate (e.g., slide) the radiator unit 140 along the track 110 to a different discrete position and release the cable 132 to permit the latch 130 to re-engage at the different discrete position and reestablish electrical coupling. Thus, displacement of the cable 132 by the first distance can transition the radiator unit 140 between operational modes, while displacement of the cable 132 by the second distance can release the radiator unit 140 for repositioning and interrupt electrical supply to the radiator unit 140.

### 4.3 Controller

Generally, the controller 104 is configured to trigger the actuator 124 and the radiator unit 140 to direct thermal radiation toward a particular surface, such as a surface specified by a user for heating. In one implementation, the controller 104 can: access or receive a definition of an object (e.g., a user's torso) to heat via the radiator unit 140; detect a position of a surface corresponding to the object; and trigger the radiator unit 140 to heat the surface. For example, the controller 104 can: access a description of an object to heat (e.g., via a wireless communication module 190); access an image captured by the optical sensor 180; detect a surface, depicted in a region of the image, that corresponds to the object based on correspondence between the definition of the object and features depicted in the image; and trigger the actuator 124 to maneuver the radiator unit 140 to locate the surface within a field of view of the radiator unit 140. Additionally, the controller 104 can trigger the actuator 124 to adjust orientation of the radiator unit 140 based on successive images captured by the optical sensor 180 that depict movement of the user within the space.

In another implementation, the controller 104 can regulate temperature of the heating element 152. In particular, as described above, the emitter 150 can emit radiation proportional to the absolute temperature of the ceramic layer 154 raised to the fourth power, as defined by the Stefan-Boltzmann Law. Accordingly, in this implementation, the controller 104 can: regulate temperature of the heating element 152 (e.g., a filament) to maintain: a target temperature range across the emitter 150; and a target thermal radiation emission (e.g., radiative power output corresponding to a target wavelength range derived from Stefan-Boltzmann Law). More specifically, the controller 104 can regulate temperature of the heating element 152 by increasing or decreasing electrical current supplied across the heating element 152 based on temperature values output from the temperature sensor.

In one example, the controller 104 can: access a target temperature range (e.g., between 1200° and 1300° Celsius) for the ceramic layer 154; read a temperature value of the ceramic layer 154 from the temperature sensor; and, in response to the temperature value falling below the target temperature range, increase current supplied to the heating element 152, such as by adjusting a pulse-width modulation (PWM) duty cycle or increasing voltage applied across the heating element 152 to drive additional resistive heating. Alternatively, in response to the temperature value exceeding the target temperature range, the controller 104 can decrease current supplied to the heating element 152, such as by reducing the pulse-width modulation (PWM) duty cycle, lowering the applied voltage, or interrupting current flow to limit resistive heating. Therefore, by regulating electrical current supplied to the heating element 152 based on temperature feedback, the controller 104 can maintain the ceramic layer 154 within the target temperature range to sustain stable emission of thermal radiation within the primary reflector 160 and maintain transfer of thermal energy to the selected surface.

### 5. Example: Heater Assembly with Pair of Radiator Units

In one example, the heater assembly 120 includes: a pair of radiator units 140 including a first radiator unit 140 and a second radiator unit 140; a mount 122 configured to couple the first radiator unit 140 and the second radiator unit 140 to the track 110; and a latch 130 configured to selectively couple the mount 122 to the track 110 at a discrete position, in the set of discrete positions, located on the track 110. In particular, the first radiator unit 140 and the second radiator unit 140 can be configured to install adjacent one another on the mount 122, and the mount 122 can be configured to translate along the track 110 to locate the first radiator unit 140 and the second radiator unit 140 over a range of positions above the space.

In this example, the heater assembly 120 can further include: a first actuator 124 configured to maneuver the first radiator unit 140 to direct thermal radiation, generated by the first radiator unit 140, toward a first surface (e.g., located below the first radiator unit 140); and a second actuator 124 configured to maneuver the second radiator unit 140 to direct thermal radiation, generated by the second radiator unit 140, toward a second surface (e.g., located below the second radiator unit 140, located below the first radiator unit 140, intersecting the first surface, or overlapping the first surface).

For example, the heater assembly 120 can be mounted to a track 110 installed at a restaurant patio over a row of tables. In this example, the heater assembly 120 can translate along the track 110, over the row of tables, to locate above a particular table. In this example, the first radiator unit 140 can direct thermal radiation toward a first user seated at the table, while the second radiator unit 140 directs thermal radiation toward a second user seated at the same table. Alternatively, the first radiator unit 140 can direct thermal radiation toward a first region of a user's body (e.g., torso), while the second radiator unit 140 directs thermal radiation toward a second region of the same user's body (e.g., face or hands). Thus, each radiator unit 140 can independently heat occupants by articulating or reorienting toward the target surface and directing concentrated thermal radiation toward individual users or user-occupied surfaces.

### 6. Surface Detection+Targeted Heating Via Radiator Unit

In one implementation, as shown in FIG. 1C, the controller 104 can: access or receive a definition of an object (e.g., a user's face, or a table surface) to heat via the radiator unit 140; detect a position of a surface corresponding to the object; and trigger the radiator unit 140 to heat the surface. For example, the radiator unit 140 can include a visual identifier 192 (e.g., a QR code) affixed to the housing 142 and uniquely associated with that radiator unit. Additionally, the heater assembly 120 can include a wireless communication module 190 configured to receive the definition of the object to heat from a mobile device, accessed by a user occupying the space, in response to the mobile device reading the visual identifier 192. More specifically, the visual identifier 192 can link the mobile device to the specific radiator unit positioned above the user. In this example, the controller 104 can: access the definition of the object to heat via the wireless communication module 190; and trigger the actuator 124 to orient the radiator unit 140 based on signals output by the suite of sensors and the definition of the object to heat received from the wireless communication module 190.

In one implementation, the controller 104 can identify a selected surface, depicted in an image captured by the optical sensor 180, based on correspondence between a received definition of the object and visual features depicted in the image. In this implementation, the controller 104 can: access a definition of an object to heat (e.g., via the wireless communication module 190); access an image captured by the optical sensor 180; detect a surface, depicted in a region of the image, based on correspondence between the definition of the object and features depicted in the image; and trigger the actuator 124 to maneuver the radiator unit 140 to locate the surface in a beam path of the radiator unit 140. For example, the controller 104 can: extract feature data from the image including edges, contours, relative geometry, or color distributions; access a template database containing geometric descriptors corresponding to selectable surface types; compare the extracted feature data to a template representing the described surface; and identify a region of the image corresponding to the described surface based on correspondence between the extracted feature data and the template.

In one example, an application executing on a mobile device accessed by a user can: access a first image of the radiator unit 140 captured by the mobile device; detect a visual identifier 192 in the first image; request a second image captured by the optical sensor 180 based on the visual identifier; render the second image on a display of the mobile device; receive selection of the object depicted in the second image; and serve the definition of the object to a server, the definition tagged with the visual identifier 192. The controller 104 can then receive the definition of the object from the server based on the visual identifier 192.

In one example, a user seated at a table may scan the visual identifier 192 via a mobile device and select “torso heating.” The controller 104 then: receives the definition corresponding to a torso region; identifies a head region within the captured image; identifies a body region located below the head region based on geometric relationship between detected features; and orients the radiator unit 140 such that the beam path intersects a region corresponding to the user's torso.

In another implementation, the controller 104 can calculate a spatial position of the surface relative to the radiator unit 140 such that the radiator unit 140 aligns the beam path of the radiator unit 140 and generates heat based on an accurate three-dimensional location of the surface. In this implementation, the controller 104 can: access an image captured by the optical sensor 180 and depicting surfaces located below the radiator unit 140; detect a surface, depicted in a region of the image, for the radiator unit 140 to heat; access a signal output by the distance sensor 182 and representing a distance between the distance sensor 182 and a reference surface; calculate a position of the surface based on the region of the image depicting the surface and the distance between the distance sensor 182 and the reference surface; and trigger the actuator 124 to align the beam path of the radiator unit 140 with the position of the surface.

In one variation, the controller 104 can estimate a distance to a detected surface based on geometric relationships within image data and known physical reference dimensions. In this variation, the controller 104 can: access an image captured by the optical sensor 180 that depicts a user occupying the space; detect a reference feature within the image based on geometric characteristics corresponding to a known object class; access stored reference dimensions corresponding to the detected feature; access a known mounting height of the radiator unit 140 and a known height of a reference surface; and calculate an estimated distance between the radiator unit 140 and the detected surface based on image scale and the stored reference dimensions. For example, the controller 104 can: access an image captured by the optical sensor 180 that depicts a user occupying a space; detect a user's head in a region of the image based on contour geometry; access an average head dimension, a known mounting height of the radiator unit 140, a known height of a reference surface (e.g., a table); and calculate an estimated distance between the radiator unit 140 and the user based on geometric relationships between image scale and known physical dimensions.

### 7. Multi-Unit Targeted Heating

In one variation, the controller 104 can coordinate operation of a first radiator unit 140 and a second radiator unit 140 to selectively assign heating targets within a shared space. In this variation, for each radiator unit 140, the controller 104 can: identify a particular surface for the radiator unit 140 to heat, such as based on a type of the surface and/or a definition of the object entered by a user; trigger an actuator 124 to articulate the radiator unit 140 to direct the beam path of the radiator unit 140 toward the surface; and trigger the radiator unit 140 to direct thermal radiation toward the surface, such as based on a target heating level (e.g., low, medium, high) selected by the user.

For example, a heater assembly 120 can include: a pair of radiator units 140 including a first radiator unit 140 and a second radiator unit 140; and a mount 122 configured to couple the first radiator unit 140 and the second radiator unit 140 to the track 110 and translate along the track 110 to locate the first radiator unit 140 and the second radiator unit 140 over a range of positions above the space. In this example, the heater assembly 120 can further include an optical sensor 180 defining a field of view intersecting the space located below the first radiator unit 140 and the second radiator unit 140.

In particular, in this example, the controller 104 can: access an image captured by the optical sensor 180 and depicting surfaces located below the first radiator unit 140 and the second radiator unit 140; and detect a first surface, depicted in a first region of the image, for the first radiator unit 140 to heat, such as based on proximity between the first surface and the first radiator unit 140. More specifically, the controller 104 can partition the image into regions corresponding to respective beam paths of the first radiator unit 140 and the second radiator unit 140 and assign a detected surface within a region to the corresponding radiator unit. The controller 104 can then detect a second surface, depicted in a second region of the image excluding the first region, for the second radiator unit 140 to heat (e.g., based on proximity between the second surface and the second radiator unit 140). In one example, the controller 104 can assign both the first radiator unit 140 and the second radiator unit 140 to heat a common surface. In another example, the controller 104 can assign the first radiator unit 140 to heat a first surface and the second radiator unit 140 to heat a different, second surface.

The controller 104 can then: trigger a first actuator 124 to maneuver the first radiator unit 140 to locate the first surface in a first beam path of the first radiator unit 140; and trigger a second actuator 124 to maneuver the second radiator unit 140 to locate the second surface in a second beam path of the second radiator unit 140.

In one variation, as shown in FIG. 1C, a wireless communication module 190 can: receive a first definition of the first object to heat from a mobile device in response to the mobile device reading a first visual identifier 192 located on the first radiator unit 140; and receive a second definition of the second object to heat from a second mobile device in response to the mobile device reading a second visual identifier 192 located on the second radiator unit 140. The controller 104 can then: access the first definition of the first object to heat and the second definition of the second object to heat via the wireless communication module 190; detect a first surface in the image based on correspondence between the first definition of the first object and features depicted in the image; and detect a second surface in the image based on correspondence between the second definition of the second object and features depicted in the image.

For example, at a table with multiple occupants, a first user seated at a first position may select heating directed toward the torso, while a second user seated opposite the first user may request heating directed toward the face. The controller 104 can: assign the first radiator unit 140 to the first user and the second radiator unit 140 to the second user; and independently maneuver each radiator unit 140 to align with the respective selected surface. Accordingly, the controller 104 can coordinate and independently control multiple radiator units 140 within a shared environment to deliver targeted heating to multiple occupants while reducing incorrect assignment of heating output and limiting wasted energy.

### 7.1 Variation: Coordination of Proximal Units

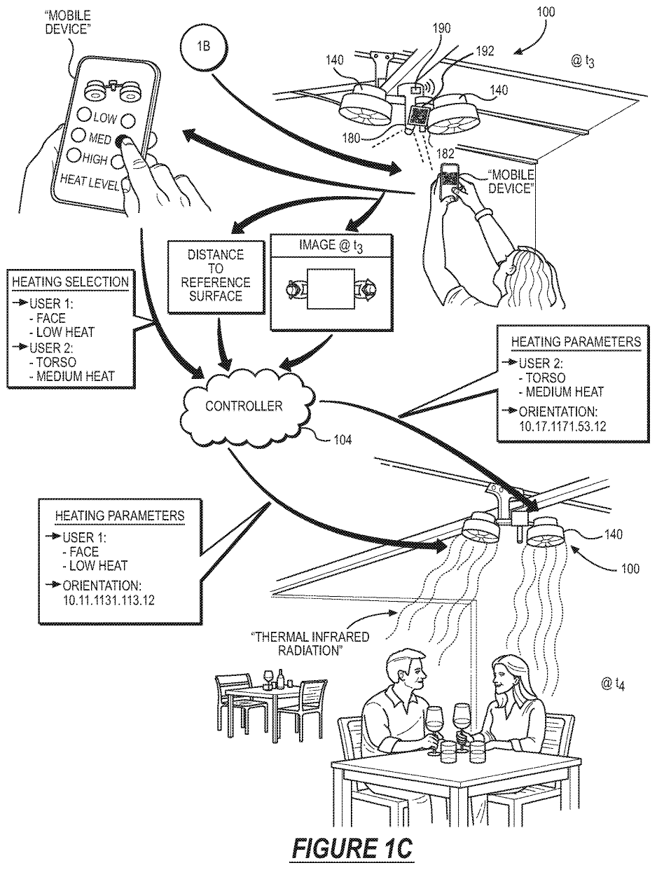

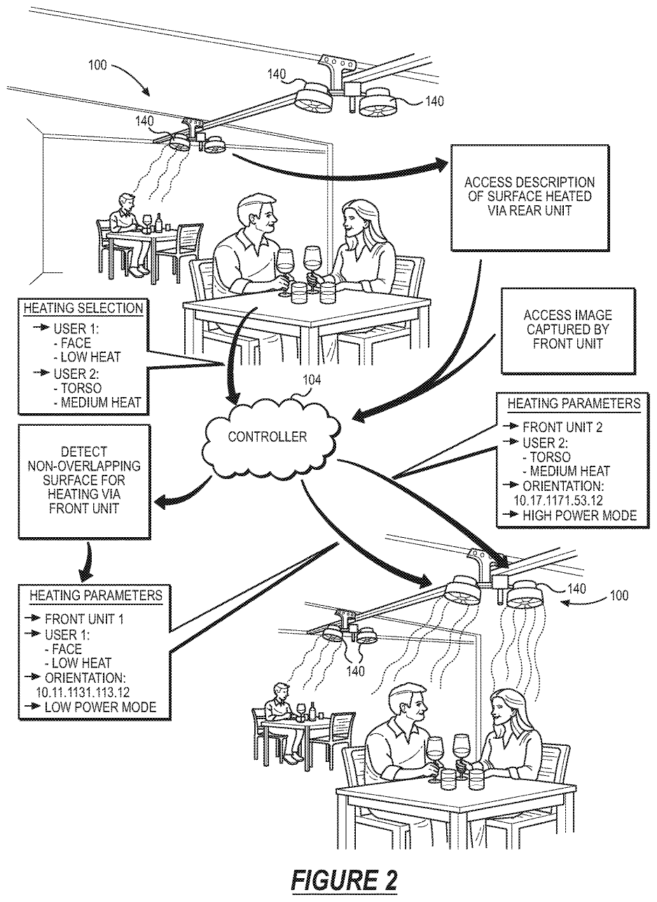

In one variation, in which multiple independent radiator units 140 are located (or relocated) proximal one another (or the radiative heating system 100 includes a pair of radiator units 140), each radiator unit 140 can cooperate to coordinate target surface assignment, such as to avoid overlapping beam paths, as shown in FIG. 2. For example, the controller 104 can selectively assign multiple radiator units 140 to a common surface based on one or more operating conditions, including an ambient air temperature proximal the radiator units 140, a size or surface area of the target object, and a distance between one or more radiator units 140 and the target surface.

In one example, a first controller 104 of a first radiator unit 140 can trigger the first radiator unit 140 to heat a first surface located below the first radiator unit 140. Then, in response to a second radiator unit 140 locating along the track 110 within a threshold distance of the first radiator unit 140, a second controller 104 of the second radiator unit 140 can access a first definition of the first surface heated by the first radiator unit 140. The second controller 104 can then: detect a second surface, non-overlapping with the first surface, for the second radiator unit 140 to heat; and trigger the second radiator unit 140 to heat the second surface. In another example, the radiative heating system 100 can include a primary controller configured to coordinate positioning and heating by the first radiator unit 140 and the second radiator unit 140.

In another example, the controller 104 can selectively restrict assignment of multiple radiator units 140 to a common surface based on environmental conditions. For example, the second controller 104 can access an ambient air temperature proximal the second radiator unit 140 and detect a distance between the second radiator unit 140 and the first surface assigned to the first radiator unit 140. In response to the ambient air temperature exceeding a threshold temperature and the distance between the second radiator unit 140 and the first surface falling below a threshold distance, the second controller 104 can assign a second surface, non-overlapping with the first surface, for heating via the second radiator unit 140. The second controller 104 can then trigger the second radiator unit 140 to locate the second surface within a second field of view of the second radiator unit 140.

Therefore, by assigning distinct target surfaces to radiator units positioned within a threshold proximity and restricting each unit to a non-overlapping beam path, the controller 104 reduces beam-path intersection between proximal radiator units, thereby decreasing localized overheating and redundant energy delivery.

### 8. Variation: Segmented Emitter

In one variation, the emitter 150 can: include multiple discrete heating elements 152; and be configured to vary intensity of emitted thermal radiation via selective activation of the discrete heating elements 152. In particular, the emitter 150 can define: a proximal region located proximal the proximal end of the emitter 150; a distal region located proximal the distal end of the emitter 150; and an intermediate region interposed between the proximal region and the distal region. More specifically, the emitter 150 is configured to operate within an operating temperature range during emission of thermal radiation, wherein the ceramic layer 154 emits predominantly within the infrared spectrum while limiting visible-band emission and avoiding excessive thermal stress on surrounding components.

Accordingly, in this variation, the radiative heating system 100 can independently supply electrical current to multiple filaments embedded within the ceramic layer 154 to vary an effective emitting length of the emitter 150. In particular, in this variation, the emitter 150 can include: a first filament extending along a first length of the first emitter, the first length coinciding with the first focal region; and a second filament extending along a second length, greater than the first length, of the first emitter (e.g., arranged concentrically about the first coiled filament). In this variation, the radiator unit 140 can be operable in: a low-power mode with current supplied to the first filament; a high-power mode with current supplied to the first filament and the second filament. Accordingly, the radiative heating system 100 can independently supply current to the first filament and the second filament to control the emission distribution of thermal radiation within the primary reflector 160 and adjust thermal radiation intensity directed toward the target surface.

### 8.1 Segmented Heat Distribution: Proximal Region

In one variation, the emitter 150 can include: a first filament embedded along a first length within the ceramic layer 154 for radiation of thermal infrared energy from the proximal region of the thermal infrared emitter; and a second filament arranged proximal the first filament and embedded along a second length within the ceramic layer 154 for radiation of thermal infrared energy from the distal region of the thermal infrared emitter. In this variation, the controller 104 can supply: a primary electrical current to the first filament (e.g., a top filament) to generate localized heating at a proximal region within the ceramic layer 154; and a secondary electrical current (e.g., less than the primary electrical current) or null electrical current to the second filament (e.g., a bottom filament).

During operation in this configuration, the primary filament generates localized heat at a proximal region of the ceramic layer 154. The ceramic layer 154 then emits thermal radiation from external surfaces of the proximal region, which propagate toward upper portions of the interior surface 162 of the primary reflector 160. The primary reflector 160 then reflects this incident thermal radiation into a narrow-collimated beam across the opening and toward a central area of the target surface. Thus, the radiator unit 140 can: increase thermal radiation intensity across a central area of the target surface; reduce angular spread of emitted radiation across a peripheral area of the target surface; and generate a focused and concentrated thermal profile at the target surface.

### 8.2 Segmented Heat Distribution: Distal Region

In another variation, the controller 104 can supply: a primary electrical current to the second filament (e.g., a bottom filament) to generate localized heating at a distal region within the ceramic layer 154; and a secondary electrical current (e.g., less than the primary electrical current) or a null electrical current to the first filament (e.g., a top filament). During operation in this configuration the primary filament generates localized heat at a distal region of the ceramic layer 154. The ceramic layer 154 then emits thermal radiation from external surfaces of the distal region, which propagate toward lower portions of the interior surface 162 of the primary reflector 160. The primary reflector 160 then reflects this incident thermal radiation into a broad infrared beam across the opening and toward a peripheral area of the target surface.

Thus, the radiator unit 140 can: decrease thermal radiation intensity across a central area of the target surface; increase angular spread of emitted radiation across a peripheral area of the target surface; and generate a diffuse and broad thermal profile at the target surface.

### 8.3 Segmented Heat Distribution: Proximal Region+Distal Region

In another variation, the controller 104 can supply electrical current to the first filament and the second filament to generate localized heating at the proximal and distal regions within the ceramic layer 154, respectively. During operation in this configuration, the primary and second filaments generate thermal energy at both the proximal and distal regions of the ceramic layer 154. The ceramic layer 154 then: conducts this thermal energy through both the proximal and distal regions of the ceramic layer 154; and radiates thermal radiation from both the proximal and distal regions (e.g., proportional to surface temperature) toward central and peripheral regions of the interior surface 162 of the primary reflector 160. The interior surface 162 of the primary reflector 160 then: reflects incident thermal radiation from both heated regions across a wider portion of its interior surface 162 as an infrared beam with an expanded angular distribution to direct a balanced concentration of thermal radiation across the entire target surface.

Thus, the radiator unit 140: distributes thermal radiation evenly across the target surface due to simultaneous radiation from both heated regions; directs a greater proportion of thermal radiation across both central and peripheral areas to increase thermal energy coverage across an entire area of the target surface; and is configured to form an infrared beam characterized by a balanced angular spread that reduces localized heating variations.

### 8.4 Intermediate Emitter

In another variation, the radiator unit 140 can implement the structure described above to form multiple independently controllable emitter segments (e.g., proximal, intermediate, distal segments) along the emitter 150 to selectively modulate thermal radiation intensity and spatial distribution across discrete areas (e.g., central, peripheral areas) of the target surface.

### 9. Variation: Retractable Emitter

In one variation, the radiator unit 140 can output a collimated thermal radiation beam, wherein a beam width (e.g., diameter, cross-sectional area) of the beam can be adjusted, such as to vary radiant flux density at the target surface. In this variation, the radiator unit 140 includes an actuator 124 (e.g., a linear actuator): coupled to a proximal end of the emitter 150; and configured to extend and retract the emitter 150 along a central longitudinal axis relative to the interior surface 162 of the primary reflector 160 to modify the spatial distribution and concentration of thermal radiation directed toward the target surface.

In this variation, the secondary actuator is configured to extend the emitter 150 along the central longitudinal axis toward the opening to direct thermal radiation toward peripheral regions of the interior surface 162 of the primary reflector 160, thus broadening the angular distribution of the thermal radiation within the primary reflector 160 and decreasing thermal radiation concentration at the target surface. Additionally, the secondary actuator is configured to retract the emitter 150 along the central longitudinal axis away from the opening to direct thermal radiation toward central regions of the interior surface 162 of the primary reflector 160, thus narrowing the angular distribution of the thermal radiation within the primary reflector 160 and increasing thermal radiation concentration at the target surface. Therefore, the radiator unit 140 can modulate thermal radiation to: concentrate or diffuse coverage of thermal radiation distribution at the target surface; and modify thermal intensity across the target surface.

### 10. Variation: Blooming Primary Reflector

In one variation, the radiator unit 140 can output a collimated thermal radiation beam, wherein a beam width (e.g., diameter, cross-sectional area) of the beam can be adjusted, such as to vary radiant flux density at the target surface. In this variation, the primary reflector 160 includes: a set of outer panels (e.g., high-emissivity coated reflectors, infrared-transparent baffles) arranged about the opening; and a secondary actuator (e.g., a servo motor, a linear actuator) configured to retract and deploy the set of outer panels about the opening. In particular, movement of the panels modulates angular spread of thermal radiation exiting the opening and thereby adjusts spatial distribution of thermal radiation across the target surface.

For example, the secondary actuator can deploy the set of outer panels (i.e., further exposing the opening) to reduce angular spread of the thermal radiation output from the primary reflector 160, thereby increasing collimation of the thermal radiation and concentrating thermal energy delivery at the surface. Conversely, the secondary actuator can retract the set of outer panels (i.e., further concealing the opening) to increase angular spread of the thermal radiation output from the primary reflector 160, thereby broadening coverage of thermal energy across the surface.

In one example, the controller 104 can trigger the secondary actuator to deploy the set of outer panels in response to low occupancy of an occupied zone to direct thermal radiation toward a primary localized target area to concentrate thermal coverage at the target surface in the occupied zone. Thus, the radiator unit 140 can focus this thermal radiation to the user within the low-occupancy space to reduce dispersion of radiant energy output from the radiator unit 140.

In another example, the controller 104 can trigger the secondary actuator to retract the set of outer panels in response to high occupancy of the occupied zone to increase the angular spread of thermal radiation to distribute thermal coverage across a secondary target area, greater than the primary target area, at the target surface in the occupied zone. Thus, the radiator unit 140 can broaden thermal radiation output to reach multiple users to maintain even heat distribution while preventing localized overheating within the occupied zone.

Therefore, the radiator unit 140 can adjust the spatial distribution of thermal radiation to accommodate varying occupancy levels within a designated zone to dynamically modulate thermal coverage at a target surface within the designated zone to maintain thermal comfort for users.

### 11. Variation: Thermal Distribution Control

In another variation, the radiator unit 140 is configured to: output an approximately-collimated thermal radiation beam characterized by a variable thermal intensity distribution across a beam cross-section; and selectively adjust the thermal intensity distribution (e.g., uniform, gradient, center-weighted) responsive to controller 104 input to direct thermal energy toward defined areas within the targeted surface.

### 11.1 Petaled Secondary Reflector

In one variation, the secondary reflector 170 includes: a set of internal panels arranged around or adjacent a periphery of the secondary reflector 170; and a secondary actuator (e.g., a servo motor, a linear actuator) coupled to the reflective panels and configured to adjust position (e.g., angular position) of the set of internal panels to modify redirection angles of thermal radiation toward the interior surface 162 of the primary reflector 160. In this variation, the secondary actuator is configured to: increase an angle of the set of internal panels to redirect thermal radiation toward peripheral regions of the primary reflector 160 to broaden angular distribution of the secondary reflector 170 relative to the primary reflector 160 resulting in reduction of thermal radiation concentration at the target surface; and decrease the angle of the set of internal panels to redirect thermal radiation toward central regions of the primary reflector 160 to narrow angular distribution of the secondary reflector 170 relative to the primary reflector 160 resulting in increase of thermal radiation concentration at the target surface.

In one example, in response to an ambient temperature of a designated zone exceeding a target temperature, the controller 104 can: trigger the secondary actuator to adjust the set of internal panels of the secondary reflector 170 to redirect thermal radiation toward peripheral regions of the primary reflector 160 in order to decrease thermal radiation concentration at the designated zone; and decrease heating intensity at the designated zone to maintain the target temperature. In another example, responsive to the ambient temperature of the designated zone falling below the target temperature, the controller 104 can: trigger the secondary actuator to decrease the angle of the set of internal panels of the secondary reflector 170 to redirect thermal radiation toward central regions of the primary reflector 160 to concentrate radiation at the designated zone; and increase heating intensity at the designated zone to maintain the target temperature.

Therefore, the controller 104 can: regulate the thermal energy available for collimation and distribution by adjusting angles of internal panels of the secondary reflector 170 to modify angular redirection of emitted thermal radiation; and maintain a target temperature for a target surface by dynamically modulating thermal radiation concentration and distribution based on measured ambient temperature of the target surface.

### 11.2 Petaled Secondary Reflector+Blooming Primary Reflector

In this variation, the radiator unit 140 can include: a set of outer panels (e.g., high-emissivity coated reflectors, infrared-transparent baffles) arranged about the opening of the primary reflector 160; a set of internal panels arranged around or adjacent a periphery of the secondary reflector 170; and a set of actuators 124 (e.g., servo motors, linear actuators) configured to retract and deploy the set of outer panels and adjust angular positions of the set of internal panels.

In this variation, the secondary actuator can: deploy the set of outer panels to narrow angular spread of the emitted infrared radiation beam; and simultaneously adjust the set of inner panels inwardly to direct thermal radiation toward central portions of the primary reflector 160, thereby cooperatively concentrating emitted thermal radiation at a central area of the target surface. Alternatively, the secondary actuator can: retract the set of outer panels to broaden angular spread of the emitted thermal radiation beam; and increases angles of the set of inner panels to redirect emitted thermal radiation toward peripheral regions of the primary reflector 160, thereby diffusing thermal radiation intensity at a central area and concentrating thermal energy across peripheral areas of the target surface.

Thus, the controller 104 can selectively modulate intensity and spatial distribution of thermal radiation output to the target surface based on occupancy conditions, ambient temperature, and/or spatial arrangement of users within the target surface.

### 12. Variation: Cold Mirror

In one variation, the radiator unit 140 further includes an infrared-transmissive dichroic reflector (or “cold mirror”): arranged at the opening to intersect the outgoing radiation beam; and configured to transmit thermal radiation while reflecting visible light away from the target surface. Thus, the radiator unit 140 blocks visible light emissions directed toward the target surface and exclusively transmits thermal radiation to the target surface.

### 13. Variation: Cooling Mode

In one variation, the heater assembly 120 can further include a fan 194 (or other blower element) configured to drive ambient air toward the space below the heater assembly 120. For example, the heater assembly 120 can be operable in: a heating mode to direct thermal radiation, generated by the radiator unit 140, toward the space below the radiator unit 140; a cooling mode to direct ambient air toward the space below the radiator unit 140 via the fan 194 (e.g., with the radiator unit 140 deactivated); and/or an intermediate mode in which the radiator unit 140 is activated and the fan 194 directs air across heated components of the heater assembly 120 to increase convective heat transfer toward the space below the radiator unit 140.

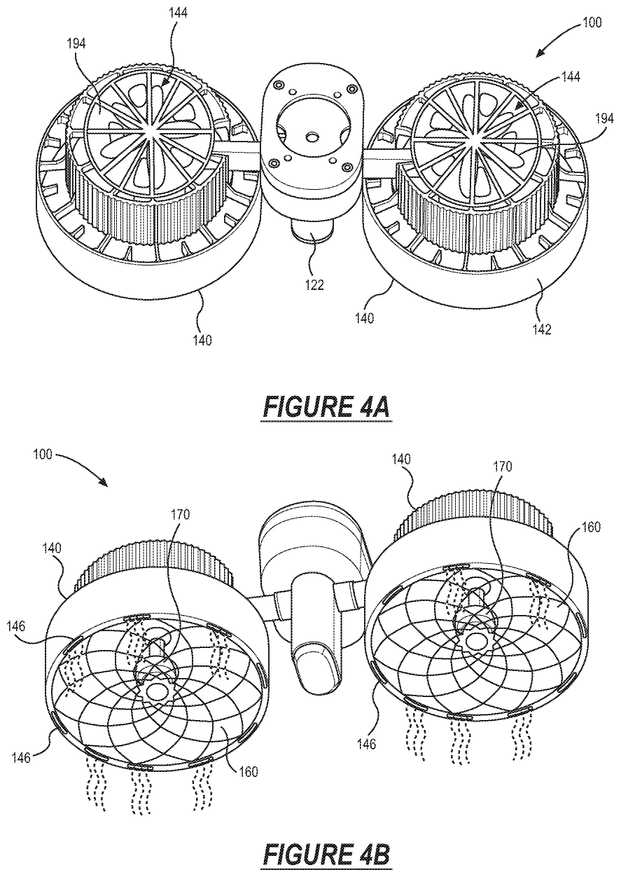

In one example, as shown in FIGS. 4A and 4B, the housing 142 of the radiator unit 140 can include: an air inlet 144 (e.g., a set of ventilation ports) arranged on a first side of the housing 142 and configured to intake ambient air; an air outlet 146 (e.g., a set of ventilation ports) arranged on a second side, opposite the first, side of the housing 142 (e.g., proximal the rim of the radiator unit 140, fluidly coupled to the opening); and a fan 194 arranged within the housing 142 across the air inlet 144 and configured to drive ambient air from the air inlet 144 toward the air outlet 146. Thus, in this example, in addition to the heating mode, the radiator unit 140 can operate in a cooling mode, wherein: the emitter 150 is deactivated; and the fan 194 is activated to drive air (e.g., cooled air, ambient air) from the air inlet 144 toward the air outlet 146, which may then flow downward to condition the space below the radiator unit 140.

Additionally, in this example, the radiator unit 140 can operate in an intermediate mode, wherein: the emitter 150 is activated to generate thermal radiation and heat internal components of the radiator unit 140; and the fan 194 is activated to drive air from the air inlet 144, through the radiator unit 140, and toward the air outlet 146, which may then flow downward to further heat the space below the radiator unit 140. More specifically, in the intermediate mode, the fan 194 can force air to flow across surfaces of the radiator unit 140 while the emitter 150 is active to increase heat transfer between heated surfaces of the radiator unit 140 (e.g., the emitter 150) and this air.

In another example, the heater assembly 120 can include a fan arranged on the mount 122 opposite the radiator unit 140. In this example, the radiator unit 140 and the fan are pivotably coupled to the mount 122 such that each can be selectively oriented toward the space below the mount 122. For example, the mount 122 can permit rotation of the radiator unit 140 and the fan approximately 180 degrees relative to one another. Accordingly, in the heating mode, the radiator unit 140 can be oriented toward the space below the mount 122 to direct thermal radiation downward. Alternatively, in the cooling mode, the fan can be oriented toward the space below the mount 122 to direct airflow downward.

In another example, the radiative heating system 100 can include a kit of interchangeable assemblies configured to transiently couple to the track 110, the kit of interchangeable assemblies including: the heater assembly 120; and a cooling assembly including a fan assembly configured to direct airflow toward the space. For example, the cooling assembly can be configured to install on the mount 122 in replacement of the heater assembly 120. Thus, an operator can selectively install either the heater assembly 120 or the cooling assembly on the mount 122 (e.g., based on season or environmental conditions).

In another example, the heater assembly 120 can include a refrigerated cooling unit integrated within or coupled to the housing 142 and configured to actively cool air drawn through the air inlet 144. In this example, the radiator unit 140 can operate in a refrigerated cooling mode, wherein: the emitter 150 is deactivated; and the refrigerated cooling unit is activated to cool air passing through the housing 142 before it exits the air outlet 146 and flows downward into the space below the radiator unit 140. The refrigerated cooling unit can include a compressor, condenser, and evaporator coil arranged within the housing 142 to provide active heat exchange such that the heater assembly 120 can reduce ambient air temperature in the space below (e.g., rather than circulating unconditioned air).

In another example, the heater assembly 120 can include a misting system configured to discharge a fine water spray toward the space below the radiator unit 140. The misting system can include a fluid reservoir coupled to the mount 122 or track 110, a pump configured to pressurize water from the reservoir, and one or more nozzles arranged on the housing 142 or mount 122 and oriented to atomize water into the space below. In a misting mode, the emitter 150 is deactivated and the pump is activated to discharge a fine mist that evaporates upon contact with ambient air, thereby reducing the perceived temperature in the space below the radiator unit 140. In another example, the heater assembly 120 can be configured to cooperate with an existing misting system installed in the space, such as a fixed overhead misting line or nozzle array.

### 14. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a track comprising a set of retention features offset by a pitch distance;
a first radiator unit:
configured to:
translate along the track; and
transiently couple to the set of retention features; and
comprising:
a first emitter configured to emit thermal radiation;
a first primary reflector comprising a first interior surface configured to:
collimate thermal radiation; and
direct thermal radiation toward a space located below the first radiator unit; and
a first secondary reflector:
arranged proximal a first distal end of the first emitter; and
configured to reflect thermal radiation, emitted by the first emitter, toward the first interior surface of the first primary reflector; and
a latch operable in:
a latched position to couple the first radiator unit to a first retention feature in the set of retention features; and
an unlatched position to:
decouple the first radiator unit from the first retention feature; and
permit translation of the first radiator unit along the track.

2. The system of claim 1:
wherein the track further comprises a first electrical interface:
coupled to a power supply; and
configured to selectively supply power to the first radiator unit; and
wherein the first radiator unit further comprises a first electrical connector configured to:
couple to the first electrical interface to supply power to the first radiator unit when the first radiator unit is coupled to the first retention feature with the latch in the latched position; and
decouple from the first electrical interface to terminate supply of power to the first radiator unit when the first radiator unit translates along the track with the latch in the unlatched position.

3. The system of claim 1:
wherein the first primary reflector:
defines a first opening; and
defines the first interior surface:
characterized by a first geometric focus;
exhibiting a concave surface geometry defining a first focal region intersecting the first geometric focus; and
configured to collimate thermal radiation emitted within the first focal region;
wherein the first emitter is arranged within the first focal region to increase thermal radiation incident upon the first interior surface of the first primary reflector; and
wherein the first secondary reflector is:
arranged within the first focal region; and
configured to reflect thermal radiation, emitted toward the first opening by the first emitter without impinging on the first interior surface, toward the first primary reflector for collimation by the first interior surface.

4. The system of claim 1, wherein the first emitter comprises:
a first tungsten heating element:
configured to resistively generate heat; and
exhibiting a first infrared emissivity; and
a first ceramic layer:
encapsulating the first tungsten heating element;
exhibiting a second infrared emissivity exceeding the first infrared emissivity; and
configured to:
chemically isolate the first tungsten heating element from oxygen; and
emit thermal radiation responsive to conductive heat transfer from the first tungsten heating element into the first ceramic layer.

5. The system of claim 1:
wherein the first interior surface of the first primary reflector exhibits concave surface geometry defining a first focal region intersecting a first geometric focus of the first interior surface;
wherein the first emitter:
is configured to operate within an operating temperature range during emission of thermal radiation; and
comprises:
a first filament extending along a first length of the first emitter, the first length coinciding with the first focal region; and
a second filament extending along a second length, greater than the first length, of the first emitter; and
wherein the first radiator unit is configured to:
in a low-power mode:
supply current to the first filament;
maintain the first emitter within the operating temperature range; and
direct thermal radiation toward the space at a first intensity; and
in a high-power mode:
supply current to the first filament and the second filament;
maintain the first emitter within the operating temperature range; and
direct thermal radiation toward the space at a second intensity greater than the first intensity.

6. The system of claim 1, further comprising a first cable:
coupled to:
a first switch configured to transition the first radiator unit between operational modes; and
the latch; and
configured to:
responsive to displacement of the first cable by a first distance, toggle the first switch to transition the first radiator unit between operational modes; and
responsive to displacement of the first cable by a second distance greater than the first distance, manipulate the latch to:
decouple the first radiator unit from the first retention feature; and
terminate supply of power to the first radiator unit.

7. The system of claim 1, further comprising:
a wireless communication module configured to receive definitions of objects for heating via the first radiator unit;
an optical sensor defining a field of view intersecting the space located below the first radiator unit;
a first actuator configured to maneuver the first radiator unit over a range of positions; and
a controller configured to:
access a definition of an object via the wireless communication module;
access a first image captured by the optical sensor;
detect a surface, depicted in a region of the first image, corresponding to the object based on correspondence between the definition of the object and features of the surface depicted in the first image; and
trigger the first actuator to maneuver the first radiator unit to locate the surface in a first field of view of the first radiator unit.

8. The system of claim 7:
wherein the first radiator unit further comprises a first visual identifier;
further comprising an application:
executing on a mobile device accessed by a user; and
configured to:
access a second image of the first radiator unit captured by the mobile device;
detect the first visual identifier in the second image;
request the first image captured by the optical sensor based on the first visual identifier;
render the first image captured by the optical sensor on a display of the mobile device;
receive selection of the object depicted in the first image; and
serve the definition of the object to a server, the definition tagged with the first visual identifier; and
wherein the controller is configured to receive the definition of the object from the server based on the first visual identifier.

9. The system of claim 1:
further comprising:
a mount:
interposed between the first radiator unit and the track; and
configured to translate along the track;
a second radiator unit located on the mount adjacent the first radiator unit;
a first actuator configured to maneuver the first radiator unit to direct thermal radiation, generated by the first radiator unit, toward a first surface located below the first radiator unit; and
a second actuator configured to maneuver the second radiator unit, independently of the first radiator unit, to direct thermal radiation, generated by the second radiator unit, toward a second surface located below the second radiator unit, the second surface different from the first surface; and
wherein the latch is:
arranged within the mount; and
configured to selectively couple the mount to the track.

10. The system of claim 1, further comprising:
a second radiator unit arranged proximal the first radiator unit;
an optical sensor defining a field of view intersecting the space located below the first radiator unit and the second radiator unit; and
a controller configured to:
access an image captured by the optical sensor and depicting surfaces located below the first radiator unit and the second radiator unit;
detect a first surface, depicted in a first region of the image, for heating via the first radiator unit based on proximity between the first surface and the first radiator unit;
detect a second surface, depicted in a second region of the image excluding the first region, for heating via the second radiator unit based on proximity between the second surface and the second radiator unit;
trigger a first actuator to maneuver the first radiator unit to locate the first surface in a first field of view of the first radiator unit; and
trigger a second actuator to maneuver the second radiator unit to locate the second surface in a second field of view of the second radiator unit.

11. The system of claim 10:
wherein the first radiator unit further comprises a first visual identifier;
wherein the second radiator unit further comprises a second visual identifier;
further comprising a wireless communication module configured to:
receive a first definition of a first object from a first mobile device in response to the first mobile device reading the first visual identifier; and
receive a second definition of a second object from a second mobile device in response to the second mobile device reading the second visual identifier; and
wherein the controller is configured to:
access the first definition of the first object and the second definition of the second object via the wireless communication module;
detect a first surface, corresponding to the first object, in the image based on correspondence between the first definition of the first object and features of the first surface depicted in the image; and
detect a second surface, corresponding to the second object, in the image based on correspondence between the second definition of the second object and features of the second surface depicted in the image.

12. The system of claim 1, further comprising:
a second radiator unit configured to translate along the track;
a first controller configured to:
access a first definition of a first object for heating via the first radiator unit;
access a first image captured by an optical sensor;
detect a first surface, corresponding to the first object, in the first image based on correspondence between the first definition of the first object and features of the first surface depicted in the first image; and
trigger the first radiator unit to locate the first surface in a first field of view of the first radiator unit; and
a second controller configured to:
access an ambient air temperature proximal the second radiator unit;
detect a distance between the second radiator unit and the first surface heated by the first radiator unit;
in response to the ambient air temperature exceeding a threshold temperature and the distance between the second radiator unit and the first surface falling below a threshold distance:
assign a second surface, non-overlapping with the first surface, for heating via the second radiator unit; and
trigger the second radiator unit to locate the second surface in a second field of view of the second radiator unit.

13. The system of claim 1, further comprising:
an optical sensor defining a field of view intersecting the space located below the first radiator unit;
a distance sensor configured to output signals representing distances between the first radiator unit and surfaces with the field of view of the optical sensor; and
a controller configured to:
access an image captured by the optical sensor and depicting surfaces located below the first radiator unit;
detect a surface, depicted in a region of the image, for heating via the first radiator unit;
access a signal output by the distance sensor and representing a distance between the distance sensor and a reference surface;
calculate a position of the surface relative to the first radiator unit based on:
the region of the image depicting the surface; and
the distance between the distance sensor and the reference surface; and
trigger a first actuator to align a first beam path of the first radiator unit with the position of the surface.

14. The system of claim 1, wherein the first radiator unit:
further comprises a fan configured to drive ambient air toward the space below the first radiator unit; and
is operable in:
a heating mode to direct thermal radiation, generated by the first radiator unit, toward the space below the first radiator unit; and
a cooling mode to direct ambient air toward the space below the first radiator unit via the fan.

15. A system comprising:
a radiator unit:
suspended from a track located over a space;
configured to translate along the track between a set of discrete positions; and
comprising:
a primary reflector:
defining an opening; and
comprising an interior surface: defining a focal region intersecting a geometric focus of the interior surface; and configured to: collimate thermal radiation; and direct thermal radiation toward the space;
an emitter:
arranged within the focal region; and
configured to emit thermal radiation;
a secondary reflector:
arranged within the focal region; and
configured to reflect thermal radiation, emitted toward the opening by the emitter without impinging on the interior surface, toward the primary reflector for collimation by the interior surface; and
an electrical connector configured to selectively couple to a set of electrical interfaces on the track while the radiator unit occupies a discrete position, in the set of discrete positions, to supply power to the radiator unit.

16. The system of claim 15, wherein the radiator unit comprises a latch operable in:
a latched position:
to transiently retain the radiator unit at the discrete position, in the set of discrete positions, located on the track; and
to couple the electrical connector to an electrical interface, in the set of electrical interfaces, located on the track at the discrete position to supply power to the radiator unit; and
an unlatched position to:
release the radiator unit from the discrete position;
permit translation of the radiator unit along the track; and
decouple the electrical connector from the electrical interface to terminate supply of power to the radiator unit.

17. The system of claim 15:
further comprising:
a mount:
interposed between the radiator unit and the track; and
configured to translate along the track;
a second radiator unit located on the mount adjacent the radiator unit;
a first actuator configured to maneuver the radiator unit to direct thermal radiation, generated by the radiator unit, toward a first surface located below the radiator unit; and
a second actuator configured to maneuver the second radiator unit, independently of the radiator unit, to direct thermal radiation, generated by the second radiator unit, toward a second surface located below the second radiator unit, the second surface different from the first surface.

18. The system of claim 15, further comprising:
an optical sensor defining a field of view intersecting the space located below the track;
a wireless communication module configured to receive a definition of an object via the radiator unit from a mobile device accessed by a user occupying the space; and
a controller configured to:
access the definition of the object via the wireless communication module;
access an image captured by the optical sensor;
detect a surface, corresponding to the object, in the image based on correspondence between the definition of the object and features of the surface depicted in the image; and
trigger the radiator unit to locate the surface in a field of view of the radiator unit for heating the surface.

19. The system of claim 15, wherein the emitter:
comprises:
a heating element configured to generate heat; and
a ceramic layer:
isolating the heating element from ambient air; and
configured to emit thermal radiation responsive to conductive heat transfer from the heating element; and
is arranged within the focal region to increase thermal radiation incident upon the interior surface of the primary reflector.

20. A system comprising:
a track:
comprising a set of discrete positions offset by a pitch distance; and
configured to supply power to a radiator unit while the radiator unit occupies a discrete position in the set of discrete positions; and
the radiator unit:
comprising:
an emitter configured to emit thermal radiation;
a primary reflector configured to direct thermal radiation toward a space located below the radiator unit; and
a secondary reflector:
arranged proximal a distal end of the emitter; and
configured to reflect thermal radiation, emitted by the emitter, toward the primary reflector; and
configured to:
in an intermediate mode:
translate along the track between the set of discrete positions while electrically isolated from the track; and
in a heating mode:
couple to the track at the discrete position, in the set of discrete positions, located over a target region of the space;
electrically couple to the track; and
direct thermal radiation toward the target region of the space.
